(19) United States
(12) Patent Application Publication
(10) Pub. No.: US 2026/0212682 A1
(43) Pub. Date: Jul. 23, 2026

(54) VEHICLE MANAGEMENT SYSTEM

(71) Applicant: TOYOTA JIDOSHA KABUSHIKI KAISHA, Toyota-shi (JP)

(72) Inventor: Kazuhiko UEDA, Chofu-shi (JP)

(73) Assignee: TOYOTA JIDOSHA KABUSHIKI KAISHA, Toyota-shi (JP)

(21) Appl. No.: 19/438,895

(22) Filed: Jan. 2, 2026

(30) Foreign Application Priority Data
Jan. 22, 2025 (JP) 2025-008918

(51) Int. Cl. G06V 20/58; B60W 60/00; G06V 20/54

(52) U.S. Cl. CPC G06V 20/58; B60W 60/00259; G06V 20/54

(57) ABSTRACT

A vehicle management system according to the present disclosure includes a plurality of vehicles, and a management device, in which each of the vehicles includes an external environment sensor configured to detect a surrounding obstacle, the management device includes a communication unit configured to receive a detection result of the external environment sensor, a controller configured to control, based on the detection result of the external environment sensor and a captured image obtained by a first surveillance camera capturing an image of a first area, an operation of the vehicles moving in the first area, and an output unit configured to output, in a case where a malfunction of the external environment sensor of some of vehicles among the vehicles moving in the first area is detected, information indicating a possibility of a failure in the external environment sensor in which the malfunction is detected.

### CROSS-REFERENCE TO RELATED APPLICATION

This application claims priority to Japanese Patent Application No. 2025-008918 filed on Jan. 22, 2025. The disclosure of the above-identified application, including the specification, drawings, and claims, is incorporated by reference herein in its entirety.

### BACKGROUND

### 1. Technical Field

The present disclosure relates to a vehicle management system.

### 2. Description of Related Art

In recent years, development of a management system that remotely manages an operation of a plurality of vehicles (that is, self-driving transport vehicles) configured to move via unmanned driving has been advanced. For example, Japanese U.S. Pat. No. 7,424,535 (JP 7424535 B) discloses a device that remotely controls a mobile object.

### SUMMARY

In the management system that remotely manages the operation of the self-driving transport vehicles, there is a demand for appropriately managing each self-driving transport vehicle by assuming a case where a camera or the like mounted in each self-driving transport vehicle is temporarily malfunctioning due to an influence of an external disturbance, or the like.

The present disclosure has been made in view of the background, and an object of the present disclosure is to provide a vehicle management system capable of appropriately managing a plurality of self-driving transport vehicles.

A vehicle management system according to the present disclosure includes a plurality of vehicles configured to move via unmanned driving, and a management device configured to manage an operation of the vehicles, in which each of the vehicles includes an external environment sensor configured to detect a surrounding obstacle,
the management device includes
a communication unit configured to receive a detection result of the external environment sensor,
a controller configured to control, based on the detection result of the external environment sensor and a captured image obtained by a first surveillance camera capturing an image of a first area, the operation of the vehicles moving in the first area, and
an output unit configured to output, in a case where a malfunction of the external environment sensor of some of vehicles among the vehicles moving in the first area is detected, information indicating a possibility of a failure in the external environment sensor in which the malfunction is detected, and
the controller is configured to control, in a case where the malfunction of the external environment sensor of each of the vehicles moving in the first area is detected, the operation of the vehicles moving in the first area based on the captured image obtained by the first surveillance camera.

The vehicle management system according to the present disclosure determines that, in a case where the malfunction of the external environment sensor of each of the vehicles moving in the first area is detected, the malfunction is temporary due to an external disturbance, such as strong wind or rain, rather than a failure of the external environment sensor, and continues to move the vehicles moving in the first area without stopping the operation, based on the captured image obtained by the first surveillance camera capturing an image of the first area. As a result, productivity of the vehicle is improved, and costs are reduced. That is, the vehicle management system according to the present disclosure can realize appropriate management of the vehicles.

In addition, in a case where a malfunction of the external environment sensor of some of the vehicles moving in the first area is detected, the vehicle management system according to the present disclosure determines that there is a high possibility of a failure of the external environment sensor instead of a temporary malfunction due to an influence of external disturbance such as a strong wind or rain, and outputs information indicating a possibility of a failure in an external environment sensor 140 in which the malfunction is detected is present. As a result, the operator can repair the vehicle equipped with the external environment sensor in which there is the possibility of the failure or guide the vehicle to an evacuation place.

According to the present disclosure, it is possible to provide a vehicle management system capable of appropriately managing a plurality of self-driving transport vehicles.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a part of a vehicle management system according to Embodiment 1;

FIG. 2 is a block diagram showing a control system of a vehicle management system according to Embodiment 1;

FIG. 3 is a block diagram showing a control system of a vehicle management system according to Embodiment 2;

FIG. 4 is a schematic diagram showing a part of a vehicle management system according to Embodiment 2;

FIG. 5 is a diagram for describing traveling control of a vehicle;

FIG. 6 is a control block diagram for describing a traveling control example 1;

FIG. 7 is a flowchart for describing the traveling control example 1;

FIG. 8 is a control block diagram for describing a traveling control example 2; and

FIG. 9 is a flowchart for describing the traveling control example 2.

### DETAILED DESCRIPTION OF EMBODIMENTS

Hereinafter, specific embodiments of the disclosure will be described in detail with reference to the drawings. Note that, the embodiments of the disclosure are not limited to the following embodiments. Further, in order to clarify the description, the following description and drawings are appropriately simplified.

### Embodiment 1

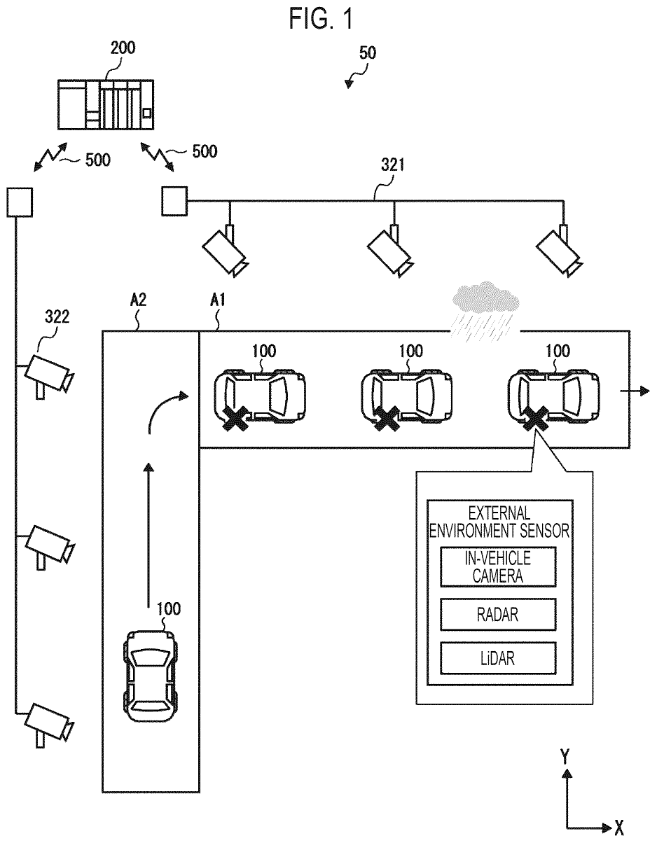

FIG. 1 is a schematic diagram showing a part of a vehicle management system 50 according to Embodiment 1. The vehicle management system 50 is applied in, for example, a vehicle manufacturing plant that manufactures a vehicle 100. In the example of FIG. 1, the vehicle management system 50 monitors and manages the vehicles 100 that move in each of an outdoor area A1 and an indoor area A2. Note that, in FIG. 1, an XY orthogonal coordinate system is shown for the description.

As shown in FIG. 1, the vehicle management system 50 includes a server 200, a surveillance camera 321, a surveillance camera 322, and a plurality of vehicles 100. Each of the vehicles 100 is, for example, a self-driving vehicle that can self-drive in a manufacturing step. In other words, each of the vehicles 100 is, for example, a vehicle configured to move via unmanned driving in a manufacturing step.

Each of the vehicles 100 is a vehicle before completion. Each of the vehicles 100 before completion is manufactured as a completed product by receiving a predetermined operation from an operator (not shown) or a robot (not shown) in areas of each manufacturing step while each of the vehicles 100 moves in a queue along a preset moving route (track). The predetermined operation is, for example, component assembly, a switch operation, welding, or inspection.

In addition, each of the vehicles 100 is equipped with an external environment sensor. The external environment sensor includes, for example, an in-vehicle camera that captures the surroundings of the vehicle, a radar that detects a surrounding obstacle of the vehicle, and a light detection and ranging (LiDAR) that detects the surrounding obstacle of the vehicle. Each of the vehicles 100 uses the external environment sensor to detect the vehicle 100 in front (or behind) during the queue traveling or to detect other obstacles around the vehicle body. For example, each of the vehicles 100 captures the vehicle 100 in front (or behind) during the queue traveling by using an in-vehicle camera that is one of the external environment sensors. Each of the vehicles 100 has a communication function and transmits the detection result of the external environment sensor (for example, data such as a captured image) to the server 200 via a network 500.

The surveillance camera 321 captures an image of the outdoor area A1 in which the vehicles 100 move in sequence. In the example of FIG. 1, the surveillance camera 321 is constituted by three cameras. The surveillance camera 322 captures an image of the indoor area A2 in which the vehicles 100 move in sequence. In the example of FIG. 1, the surveillance camera 322 is constituted by three cameras.

The server 200 monitors the vehicles 100 that move in the area A1 based on the captured image of the surveillance camera 321 that captures the image of the area A1 and the detection result such as the captured image received from the external environment sensor of each of the vehicles 100 that move in the area A1. Further, the server 200 manages the vehicles 100 that move in the area A1 based on the same information. The server 200 monitors the vehicles 100 that move in the area A2 based on the captured image of the surveillance camera 322 that captures the image of the area A2 and the detection result such as the captured image received from the external environment sensor of each of the vehicles 100 that move in the area A2. Further, the server 200 manages the vehicles 100 that move in the area A2 based on the same information. For example, the server 200 monitors whether each of the vehicles 100 is moving on a predetermined route or monitors whether a predetermined operation is being performed on each of the vehicles 100 based on the acquired captured image. Further, the server 200 controls the movement of each of the vehicles 100 while the position of each of the vehicles 100 is estimated based on the acquired captured image or the like. The server 200 is a vehicle management device and is also referred to as a vehicle management system as a standalone device.

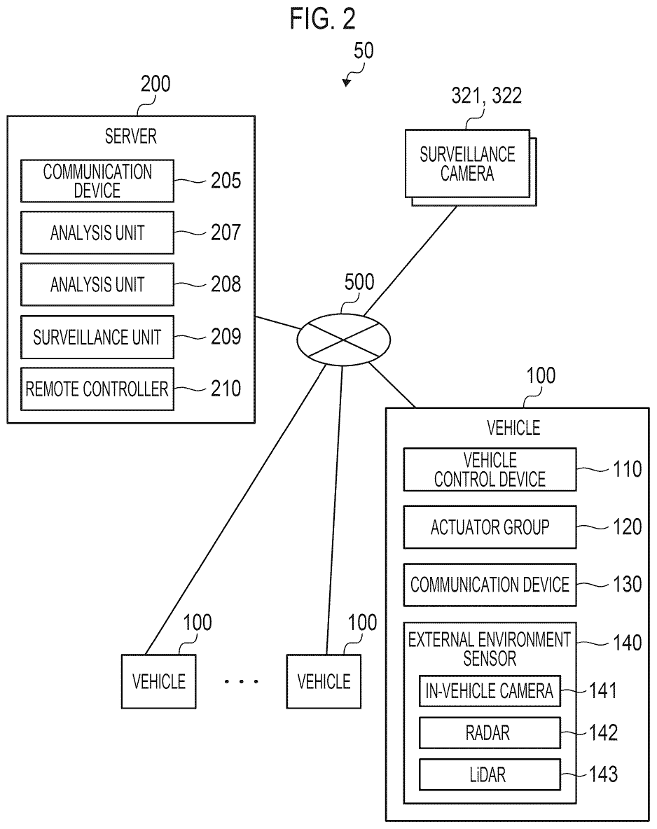

Next, a control system of the vehicle management system 50 will be described with reference to FIG. 2. FIG. 2 is a block diagram showing a control system of the vehicle management system 50.

As shown in FIG. 2, the server 200 includes at least a communication device 205, an analysis unit 207, an analysis unit 208, and a remote controller 210. Each of the vehicles 100 includes a vehicle control device 110, an actuator group 120, a communication device 130, and an external environment sensor 140. The external environment sensor 140 has three kinds of sensors, that is, an in-vehicle camera 141, a radar 142, and a LiDAR 143. Note that the external environment sensor 140 is not limited to the three kinds of sensors, and may have fewer than three kinds of sensors or four or more kinds of sensors. The server 200 is not limited to being constituted by a single device physically, and may be constituted by a plurality of devices that is distributed. For example, the analysis units 207, 208 may be constituted by a single device physically, or may be constituted by each of different devices.

In the server 200, the communication device 205 communicates with the surveillance cameras 321, 322 and each of the vehicles 100 via the network 500. For example, the communication device 205 receives data, such as a captured image, from the surveillance cameras 321, 322 or each of the vehicles 100, or transmits information related to vehicle control to each of the vehicles 100.

The analysis unit 207 analyzes each of the captured image obtained by the surveillance camera 321 that captures the area A1 and the captured image obtained by the surveillance camera 322 that captures the area A2. Specifically, the communication device 205 receives data, such as a captured image, from each of the surveillance camera 321 that captures the area A1 and the surveillance camera 322 that captures the area A2. The analysis unit 207 specifies, for example, the shape of each of the vehicles 100 reflected in the captured image and the peripheral environment of each of the vehicles 100 by analyzing each of the received captured image obtained by the surveillance camera 321 and the received captured image obtained by the surveillance camera 322. As a result, it is possible to specify the position and the orientation of each of the vehicles 100 in the area A1, the traveling state of each of the vehicles 100 in the area A1, and the like. In addition, it is possible to specify the position and the orientation of each of the vehicles 100 in the area A2, the traveling state of each of the vehicles 100 in the area A2, and the like.

The analysis unit 208 analyzes each of the detection result of the external environment sensor 140 mounted on each of the vehicles 100 moving in the area A1 and the detection result of the external environment sensor 140 mounted on each of the vehicles 100 moving in the area A2. Specifically, the communication device 205 receives the detection result (data such as a captured image) of the external environment sensor 140 mounted on each of the vehicles 100 moving in the area A1. In addition, the communication device 205 receives the detection result (data such as a captured image) of the external environment sensor 140 mounted on each of the vehicles 100 moving in the area A2. The analysis unit 208 specifies, for example, the shape of the vehicle in front (or behind) of each of the vehicles 100 and the peripheral environment of each of the vehicles 100 by analyzing the received detection result. As a result, it is possible to specify the inter-vehicle distance between each of the vehicles 100 and the vehicle in front (or behind) of each of the vehicles 100 in the area A1, the position and the orientation of each of the vehicles 100 in the area A1, the traveling state of each of the vehicles 100 in the area A1, and the like. In addition, it is possible to specify the inter-vehicle distance between each of the vehicles 100 and the vehicle in front (or behind) of each of the vehicles 100 in the area A2, the position and the orientation of each of the vehicles 100 in the area A2, the traveling state of each of the vehicles 100 in the area A2, and the like.

A surveillance unit 209 surveils each of the vehicles 100 moving in the areas A1, A2 based on the analysis result of each of the analysis units 207, 208. For example, the surveillance unit 209 surveils whether each of the vehicles 100 is moving while a predetermined inter-vehicle distance is maintained. In addition, the surveillance unit 209 monitors whether each vehicle 100 moves along a scheduled route or further monitors whether a scheduled operation is performed on each vehicle 100.

The remote controller 210 remotely controls each of the vehicles 100 by transmitting information related to vehicle control to each of the vehicles 100 based on the surveillance result (including the position information of each of the vehicles 100) by the surveillance unit 209. Specifically, the communication device 205 transmits the information related to a vehicle control instruction by the remote controller 210 to each of the vehicles 100. In each of the vehicles 100, the communication device 130 receives the information related to the vehicle control from the server 200, and the vehicle control device 110 causes the vehicle to travel by the control of the actuator group 120 in accordance with the received information related to the vehicle control.

Here, in particular, each of the vehicles 100 moving in the outdoor area A1 is easily affected by an external disturbance, such as strong wind or rain. Specifically, the external environment sensor 140 (at least any one of the in-vehicle camera 141, the radar 142, and the LiDAR 143) mounted on each of the vehicles 100 moving in the area A1 may be temporarily malfunctioning due to the influence of the external disturbance. As an example, the view of the in-vehicle camera 141 mounted on each of the vehicles 100 moving in the area A1 may be blocked by rain, or the in-vehicle camera 141 may be severely shaken by strong wind, and thus the in-vehicle camera 141 may be temporarily malfunctioning.

Therefore, in a case where the malfunction of the external environment sensor 140 of each of the vehicles 100 that move in the area A1 is detected (preferably, in a case where the malfunction of all the external environment sensors 140 of the vehicles 100 that move in the area A1 is detected), the surveillance unit 209 determines that the malfunction is not a failure of the external environment sensor 140. Then, the surveillance unit 209 determines that the malfunction is a temporary malfunction due to the influence of the external disturbance such as a strong wind or rain. The surveillance unit 209 may have a function of detecting the malfunction of the external environment sensor 140 of each of the vehicles 100 moving in the area A1, or may acquire a signal indicating the malfunction of the external environment sensor 140 from each of the vehicles 100.

In this case, the remote controller 210 does not use the detection result of the external environment sensor 140 of each of the vehicles 100 that move in the area A1. Then, the remote controller 210 remotely controls the vehicles 100 that move in the area A1 based on the captured image (more specifically, the analysis result of the captured image) of the surveillance camera 321, and causes the vehicles 100 to continue to move. As a result, in the vehicle management system 50, the productivity of the vehicle is improved, and the costs are reduced. That is, the vehicle management system 50 can realize the appropriate management of the vehicles 100. At this time, the remote controller 210 may decrease the traveling speed of the vehicles 100 that travel in the area A1 or increase the inter-vehicle distance between the vehicles 100 that travel in the area A1.

The surveillance unit 209 may detect the malfunction of less than a predetermined number (for example, less than two) of the three kinds of sensors of the in-vehicle camera 141, the radar 142, and the LiDAR 143 included in the external environment sensor 140 of each vehicle 100 that moves in the area A1. In this case, it may be determined that it is possible to cause each vehicle 100 that moves in the area A1 to continue to move. In this case, the remote controller 210 uses the detection result of the sensor of which the malfunction is not detected among the three kinds of sensors included in the external environment sensor 140 of each vehicle 100. Further, the remote controller 210 remotely controls the vehicles 100 that move in the area A1 based on the captured image of the surveillance camera 321, and causes the vehicles 100 to continue to move. At this time, the remote controller 210 may decrease the traveling speed of the vehicles 100 that travel in the area A1 or increase the inter-vehicle distance between the vehicles 100 that travel in the area A1.

On the other hand, the surveillance unit 209 may detect the malfunction of the three kinds of sensors of the in-vehicle camera 141, the radar 142, and the LiDAR 143 included in the external environment sensor 140 of each vehicle 100 that moves in the area A1. Then, in a case where the malfunction is detected in the number of kinds of sensors that is equal to or more than a predetermined number of kinds (for example, two or more kinds) of the sensors among the sensors, it may be determined that it is impossible to cause each vehicle 100 that moves in the area A1 to continue to move. In this case, the remote controller 210 remotely controls the vehicles 100 moving in the area A1 to stop moving. The determination criterion for determining whether each of the vehicles 100 moving in the area A1 can be continuously moved or the traveling speed and the inter-vehicle distance of each of the vehicles 100 moving in the area A1 may be optionally decided according to the environment of the area A1. For example, in a case where the entry of the operator is permitted in the area A1, the determination criterion that each of the vehicles 100 during the movement in the area A1 can be continuously moved for safety may be strictly set.

As described above, in a case where the malfunction of the external environment sensor 140 of each of the vehicles 100 that move in the area A1 is detected, the vehicle management system 50 according to the present disclosure determines that the malfunction is not a failure of the external environment sensor 140. Then, it is determined that the malfunction is a temporary malfunction due to the external disturbance such as a strong wind or rain. At this time, the vehicle management system 50 according to the present disclosure continues to move the vehicles 100 moving in the area A1 without stopping the operation, based on the captured image obtained by the surveillance camera 321 that captures the area A1. As a result, productivity of the vehicle is improved, and costs are reduced. That is, the vehicle management system 50 according to the present disclosure can realize the appropriate management of the vehicles 100.

In the present disclosure, a case has been described as an example in which, in a case where the malfunction of the external environment sensor 140 of each of the vehicles 100 that move in the area A1 is detected, the surveillance unit 209 determines that the malfunction is a temporary malfunction due to the influence of the external disturbance such as a strong wind or rain, instead of a failure of the external environment sensor 140. However, the present disclosure is not limited thereto. For example, the same applies to a case where the surveillance unit 209 detects the malfunction of the external environment sensor 140 of each of the vehicles 100 that move in a predetermined area (including the area A2) where the external disturbance other than the area A1 is likely to occur. In this case, it may be determined that the malfunction is a temporary malfunction due to the influence of the external disturbance such as a strong wind or rain, instead of a failure of the external environment sensor 140. In this case, the remote controller 210 does not use the detection result of the external environment sensor 140 of each of the vehicles 100 that move in the predetermined area. Then, the remote controller 210 continues to move the vehicles 100 moving in the predetermined area by remote control based on the captured image obtained by the surveillance camera that captures an image of the predetermined area (more specifically, the analysis result of the captured image). The determination criterion for determining whether each of the vehicles 100 can be continuously moved may be set for each area.

Similarly, the surveillance unit 209 may detect the malfunction of the three kinds of sensors of the in-vehicle camera 141, the radar 142, and the LiDAR 143 included in the external environment sensor 140 of each vehicle 100 that moves in the predetermined area. Then, in a case where the malfunction of less than a predetermined number (for example, less than two) of kinds of the sensors among the sensors is detected, the surveillance unit 209 may determine that it is possible to cause each vehicle 100 that moves in the predetermined area to continue to move. In this case, the remote controller 210 uses the detection result of the sensor of which the malfunction is not detected among the three kinds of sensors included in the external environment sensor 140 of each vehicle 100. Further, the remote controller 210 remotely controls the vehicles 100 that move in the predetermined area based on the captured image of the surveillance camera 321, and causes the vehicles 100 to continue to move. At this time, the remote controller 210 may decrease the traveling speed of the vehicles 100 that travel in the predetermined area or increase the inter-vehicle distance between the vehicles 100 that travel in the predetermined area.

On the other hand, the surveillance unit 209 may detect the malfunction of the three kinds of sensors of the in-vehicle camera 141, the radar 142, and the LiDAR 143 included in the external environment sensor 140 of each vehicle 100 that moves in the predetermined area. Then, in a case where the malfunction is detected in the number of kinds of sensors that is equal to or more than a predetermined number of kinds (for example, two or more kinds) of the sensors among the sensors, it may be determined that it is impossible to cause each vehicle 100 that moves in the predetermined area to continue to move. In this case, the remote controller 210 remotely controls the vehicles 100 moving in the predetermined area to stop moving. The determination criterion for determining whether each of the vehicles 100 moving in the predetermined area can be continuously moved or the traveling speed and the inter-vehicle distance of each of the vehicles 100 moving in the predetermined area may be optionally decided according to the environment of the predetermined area. For example, in a case where the entry of the operator is permitted in the predetermined area, the determination criterion that each of the vehicles 100 during the movement in the predetermined area can be continuously moved for safety may be strictly set.

In addition, the vehicle management system 50 can manage the operation status of the external environment sensor 140 provided in the vehicle 100, the area in which the vehicle 100 moves, and the control content of the operation of the vehicle 100 in association with each other. Therefore, a database in which a plurality of combinations of the information is stored may be further provided. In this case, the remote controller 210 extracts the control content corresponding to the operation status of the external environment sensor 140 provided in each vehicle 100 that moves in the area A1 from the database. Then, the remote controller 210 remotely controls the operation of each vehicle 100 that moves in the area A1 in accordance with the extracted control content. The operation status of the external environment sensor 140 is, for example, information on the presence or absence of the malfunction of each of one or more kinds of sensors included in the external environment sensor 140.

### Embodiment 2

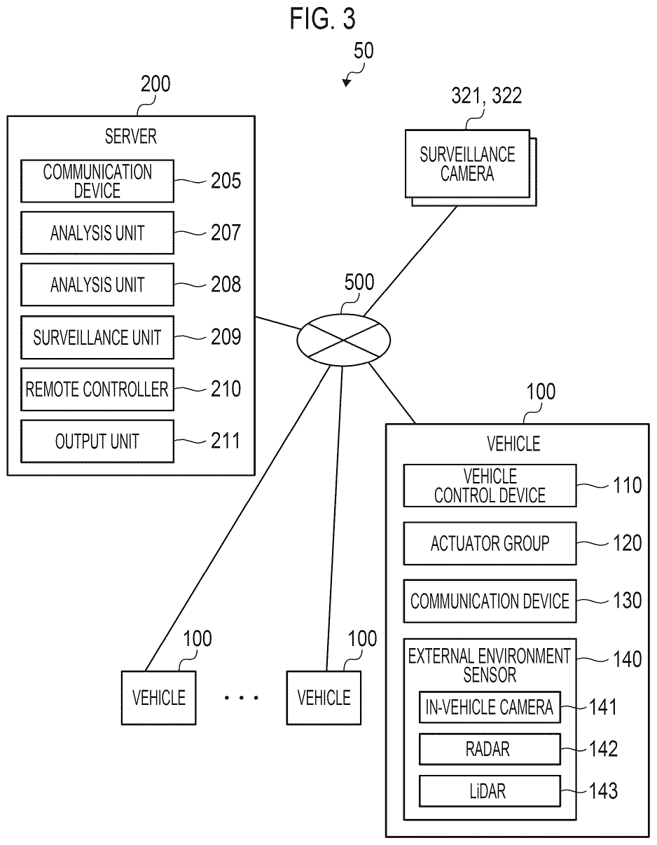

FIG. 3 is a block diagram showing a control system of the vehicle management system 50 according to Embodiment 2. As shown in FIG. 3, the server 200 provided in the vehicle management system 50 according to Embodiment 2 further includes an output unit 211. Since the other configurations of the vehicle management system 50 according to Embodiment 2 are the same as the configurations of the vehicle management system 50 according to Embodiment 1, the description thereof will be omitted.

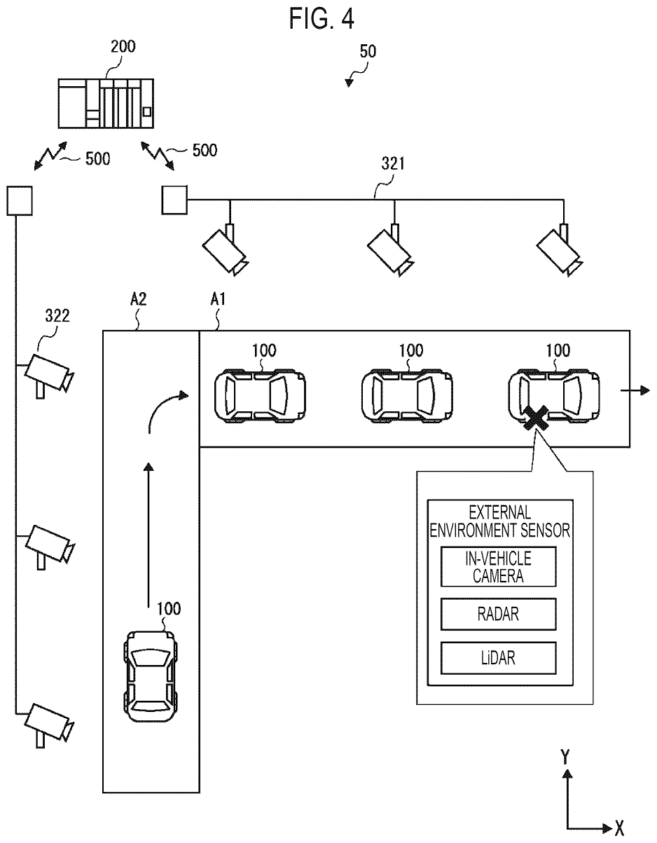

FIG. 4 is a schematic diagram showing a part of the vehicle management system 50 according to Embodiment 2. For example, in a case where the malfunction of the external environment sensor 140 of some (one in the example of FIG. 4) of the vehicles 100 that move in the area A1 is detected, the surveillance unit 209 determines that the malfunction is not a temporary malfunction due to the influence of the external disturbance such as a strong wind or rain. Then, the surveillance unit 209 determines that there is a high possibility of a failure of the external environment sensor 140. The malfunction of the external environment sensor 140 includes the malfunction of a part of a plurality of kinds of sensors included in the external environment sensor 140. In this case, the output unit 211 outputs information indicating that there is a possibility of a failure in the external environment sensor 140 in which the malfunction has been detected. The output unit 211 outputs the information indicating that there is a possibility of a failure in the external environment sensor 140 in which the malfunction has been detected, as a voice output from a speaker, as a display on a monitor, or as a notification to a mobile terminal held by the operator of the area A1. As a result, the operator can repair the vehicle 100 equipped with the external environment sensor 140 that may fail or guide the vehicle 100 to the evacuation place. Further, the remote controller 210 may remotely control the vehicle 100 equipped with the external environment sensor 140 determined to be highly likely to fail to perform an emergency stop, to be evacuated to the evacuation place, or to travel on the detour route.

As described above, in a case where the malfunction of the external environment sensor 140 of some of the vehicles 100 that move in the area A1 is detected, the vehicle management system 50 according to the present disclosure determines that the malfunction is not a temporary malfunction due to the influence of the external disturbance such as a strong wind or rain. Then, the vehicle management system 50 determines that there is a high possibility of a failure of the external environment sensor 140. At this time, the vehicle management system 50 according to the present disclosure outputs information indicating that there is a possibility of a failure in the external environment sensor 140 in which the malfunction has been detected. As a result, the operator can repair the vehicle 100 equipped with the external environment sensor 140 that may fail or guide the vehicle 100 to the evacuation place.

In the present disclosure, a case has been described as an example in which, in a case where the malfunction of the external environment sensor 140 of some of the vehicles 100 that move in the area A1 is detected, the surveillance unit 209 determines that the malfunction is not a temporary malfunction due to the influence of the external disturbance such as a strong wind or rain, but there is a high possibility of a failure of the external environment sensor 140. However, the present disclosure is not limited thereto. For example, the surveillance unit 209 may determine that the malfunction is not a temporary malfunction due to the influence of the external disturbance such as a strong wind or rain, even in a case where the malfunction of the external environment sensor 140 of some of the vehicles 100 that move in a predetermined area (including the area A2) other than the area A1 is detected. Then, the surveillance unit 209 may determine that there is a high possibility of a failure of the external environment sensor 140. In this case, the output unit 211 outputs information indicating that there is a possibility of a failure in the external environment sensor 140 in which the malfunction has been detected. Further, the remote controller 210 may remotely control the vehicle 100 equipped with the external environment sensor 140 determined to be highly likely to fail to perform an emergency stop, to be evacuated to the evacuation place, or to travel on the detour route. The determination criterion for determining whether the external environment sensor 140 is failed may be set for each area.

Hereinafter, a traveling control example for controlling traveling of the vehicle 100 will be described in the system 50 related to the manufacturing of the vehicle including the vehicle management system according to the present disclosure.

### A. Traveling Control Example 1

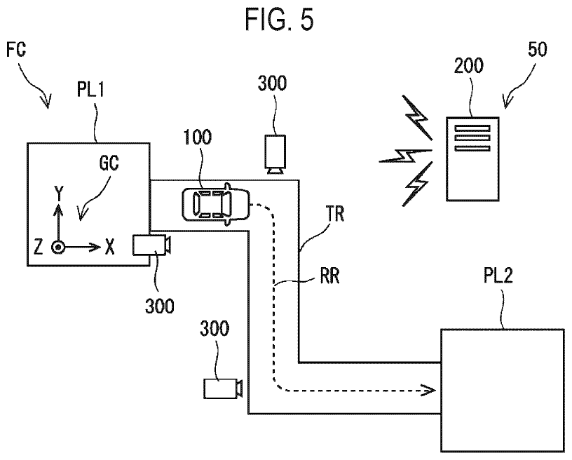

FIG. 5 is a conceptual diagram showing a configuration of the system 50 in traveling control example 1. The system 50 includes one or more vehicles 100 as a mobile object, the server 200, and one or more external sensors 300.

In addition, in a case where the mobile object is other than the vehicle, the expression of “vehicle” and “car” in the present disclosure can be replaced with “mobile object” as appropriate, and the expression of “travel” can be replaced with “move” as appropriate.

The vehicle 100 is configured to travel via unmanned driving. The “unmanned driving” means driving that does not depend on a traveling operation of a passenger. The traveling operation means an operation related to at least any one of “traveling”, “turning”, and “stopping” of the vehicle 100. The unmanned driving is implemented by automatic or manual remote control using a device located outside the vehicle 100 or by autonomous control of the vehicle 100. The passenger who does not perform the traveling operation may get on the vehicle 100 that travels via the unmanned driving. Examples of the passenger who does not perform the traveling operation include a person who simply sits on a seat of the vehicle 100 and a person who performs work different from the traveling operation, such as assembly, inspection, or operation of switches, in a state of getting on the vehicle 100. The driving via the traveling operation performed by the passenger may be referred to as “manned driving”.

In the present specification, the “remote control” includes “complete remote control” in which all the operations of the vehicle 100 are completely decided from the outside of the vehicle 100, and “partial remote control” in which a part of the operations of the vehicle 100 are decided from the outside of the vehicle 100. In addition, the “autonomous control” includes “complete autonomous control” in which the vehicle 100 autonomously controls the operation thereof without receiving any information from an external device of the vehicle 100, and “partial autonomous control” in which the vehicle 100 autonomously controls the operation thereof by using the information received from the external device of the vehicle 100. In addition, the “autonomous control” includes “complete autonomous control” and “partial autonomous control”. In the “complete autonomous control”, the vehicle 100 autonomously controls its own operation without receiving any information from a device outside the vehicle 100. In the “partial autonomous control”, the vehicle 100 autonomously controls its own operation using information received from a device outside the vehicle 100.

In the present embodiment, the system 50 is used in a factory FC that manufactures the vehicle 100. A reference coordinate system of the factory FC is a global coordinate system GC. That is, any position in the factory FC is represented by coordinates of X, Y, and Z in the global coordinate system GC. The factory FC includes a first place PL1 and a second place PL2. The first place PL1 and the second place PL2 are connected by a track TR on which the vehicle 100 can travel. A plurality of external sensors 300 is installed in the factory FC along the track TR. A position of each external sensor 300 in the factory FC is adjusted in advance. The vehicle 100 moves via the unmanned driving from the first place PL1 to the second place PL2 along the track TR.

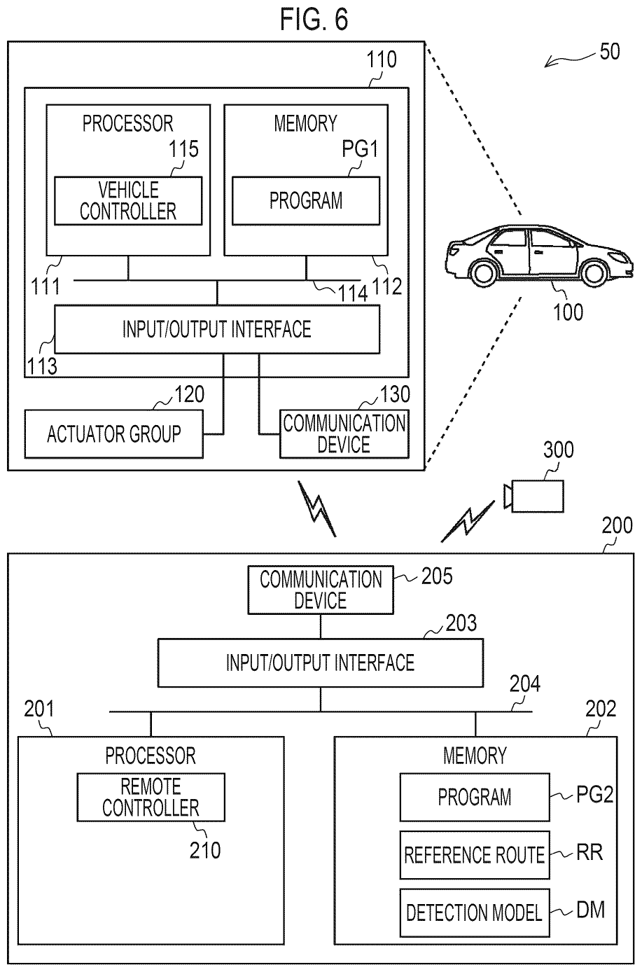

FIG. 6 is a block diagram showing the configuration of the system 50. The vehicle 100 includes the vehicle control device 110 for controlling each part of the vehicle 100 and the actuator group 120 including one or more actuators that are driven under the control of the vehicle control device 110. Further, the vehicle 100 also includes the communication device 130 for communicating with an external device such as the server 200 by wireless communication. The actuator group 120 includes an actuator of a drive device for accelerating the vehicle 100, an actuator of a steering device for changing a traveling direction of the vehicle 100, and an actuator of a braking device for decelerating the vehicle 100.

The vehicle control device 110 is configured by a computer including a processor 111, a memory 112, an input/output interface 113, and an internal bus 114. The processor 111, the memory 112, and the input/output interface 113 are connected to be bidirectionally communicable with each other via the internal bus 114. The actuator group 120 and the communication device 130 are connected to the input/output interface 113. The processor 111 executes a program PG1 stored in the memory 112 to implement various functions including functions as a vehicle controller 115.

The vehicle controller 115 controls the actuator group 120 to cause the vehicle 100 to travel. The vehicle controller 115 can cause the vehicle 100 to travel by controlling the actuator group 120 using a traveling control signal received from the server 200. The traveling control signal is a control signal for causing the vehicle 100 to travel. In the present embodiment, the traveling control signal includes the acceleration and a steering angle of the vehicle 100 as parameters. In other embodiments, the traveling control signal may include a speed of the vehicle 100 as the parameter instead of or in addition to the acceleration of the vehicle 100.

The server 200 is configured by a computer including a processor 201, a memory 202, an input/output interface 203, and an internal bus 204. The processor 201, the memory 202, and the input/output interface 203 are connected to be bidirectionally communicable with each other via the internal bus 204. The communication device 205 for communicating with various devices outside the server 200 is connected to the input/output interface 203. The communication device 205 can communicate with the vehicle 100 via wireless communication, and can communicate with each external sensor 300 via wired communication or wireless communication. The processor 201 implements various functions including a function as the remote controller 210 by executing a program PG2 stored in the memory 202.

The remote controller 210 acquires the detection result by the sensor, and generates the traveling control signal for controlling the actuator group 120 of the vehicle 100 by using the detection result. Then, the remote controller 210 transmits the traveling control signal to the vehicle 100 to cause the vehicle 100 to travel by the remote control. In addition, the remote controller 210 may generate, for example, a control signal for controlling various accessories provided in the vehicle 100 or actuators for operating various kinds of equipment, such as a wiper, a power window, or a lamp, in addition to the traveling control signal, and output the generated control signal. That is, the remote controller 210 may operate the various kinds of equipment or the various accessories via the remote control. For example, the remote controller 210 may include a function of the analysis units 207, 208, or the surveillance unit 209 shown separately from the remote controller 210 in FIG. 2.

The external sensor 300 is a sensor located outside the vehicle 100. The external sensor 300 according to the present embodiment is a sensor that captures the vehicle 100 from the outside of the vehicle 100. The external sensor 300 includes a communication device (not shown), and can communicate with other devices, such as the server 200, via wired communication or wireless communication. The external sensor 300 includes the function of the surveillance cameras 321, 322 shown in FIG. 2.

Specifically, the external sensor 300 is configured by a camera. The camera as the external sensor 300 captures a captured image including the vehicle 100 and outputs the captured image as a detection result.

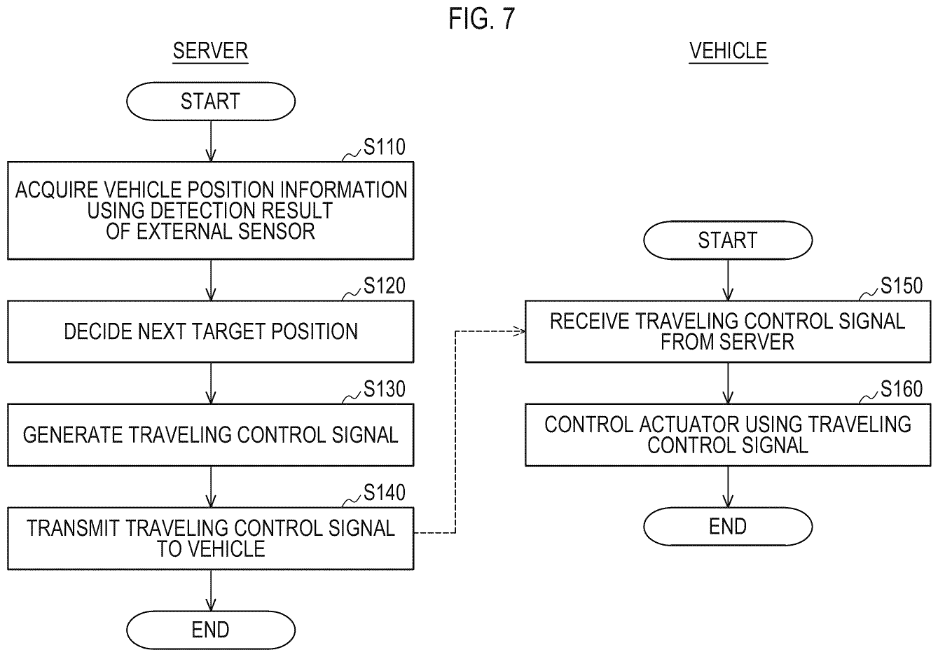

FIG. 7 is a flowchart showing a processing procedure of traveling control of the vehicle 100 in the traveling control example. In the processing procedure of FIG. 7, the processor 201 of the server 200 executes the program PG2 to function as the remote controller 210. In addition, the processor 111 of the vehicle 100 executes the program PG1 to function as the vehicle controller 115.

In step S110, the processor 201 of the server 200 acquires the vehicle position information of the vehicle 100 by using the detection result output from the external sensor 300. The vehicle position information is position information that is a basis for generating the traveling control signal. In the present embodiment, the vehicle position information includes the position and the direction of the vehicle 100 in the global coordinate system GC of the factory FC. Specifically, in step S110, the processor 201 acquires the vehicle position information by using the captured image acquired from the camera as the external sensor 300.

Specifically, in S110, the processor 201 detects, for example, the external shape of the vehicle 100 from the captured image and calculates coordinates of a positioning point of the vehicle 100 in a coordinate system of the captured image, that is, a local coordinate system. Then, the processor 201 acquires the position of the vehicle 100 by converting the calculated coordinates into coordinates in the global coordinate system GC. The outer shape of the vehicle 100 included in the captured image can be detected, for example, by inputting the captured image to a detection model DM using artificial intelligence. The detection model DM is prepared, for example, inside the system 50 or outside the system 50, and is stored in advance in the memory 202 of the server 200. Examples of the detection model DM include a trained machine learning model that has been trained such that any one of semantic segmentation and instance segmentation is implemented. As the machine learning model, for example, a convolutional neural network (CNN) that has been trained by supervised learning using a training data set can be used. The training data set has, for example, a plurality of training images including the vehicle 100 and a label indicating whether each area in the training image is an area indicating the vehicle 100 or an area indicating an area other than the vehicle 100. When the CNN is trained, it is preferable that parameters of the CNN are updated such that an error between an output result of the detection model DM and the label is reduced by backpropagation (error backpropagation method). In addition, the processor 201 uses, for example, an optical flow method. As a result, the processor 201 estimates the orientation of the vehicle 100 based on the movement vector of the vehicle 100 calculated from the change in the position of the feature point of the vehicle 100 between the frames of the captured image. As a result, the processor 201 can acquire the orientation of the vehicle 100.

In step S120, the processor 201 of the server 200 decides the target position to which the vehicle 100 should go next. In the present embodiment, the target position is represented by the coordinates of X, Y, and Z in the global coordinate system GC. The reference route RR that is a route along which the vehicle 100 should travel is stored in advance in the memory 202 of the server 200. The route is represented by a node indicating a departure point, a node indicating a passing point, a node indicating a destination, and a link connecting each of the nodes. The processor 201 decides the target position to which the vehicle 100 should head next by using the vehicle position information and the reference route RR. The processor 201 decides the target position on the reference route RR ahead of the current position of the vehicle 100.

In step S130, the processor 201 of the server 200 generates the traveling control signal for causing the vehicle 100 to travel toward the decided target position. The processor 201 calculates the traveling speed of the vehicle 100 from the transition of the position of the vehicle 100, and compares the calculated traveling speed with a target speed. As a whole, the processor 201 decides the acceleration such that the vehicle 100 is accelerated when the traveling speed is lower than the target speed, and decides the acceleration such that the vehicle 100 is decelerated when the traveling speed is higher than the target speed. In addition, when the vehicle 100 is positioned on the reference route RR, the processor 201 decides the steering angle and the acceleration such that the vehicle 100 does not deviate from the reference route RR. In a case where the vehicle 100 is not located on the reference route RR, in other words, in a case where the vehicle 100 deviates from the reference route RR, the steering angle and the acceleration are decided such that the vehicle 100 returns to the reference route RR.

In step S140, the processor 201 of the server 200 transmits the generated traveling control signal to the vehicle 100. The processor 201 repeatedly executes, at a predetermined cycle, the acquisition of the position of the vehicle 100, the decision of the target position, the generation of the traveling control signal, the transmission of the traveling control signal, and the like.

In step S150, the processor 111 of the vehicle 100 receives the traveling control signal transmitted from the server 200. In step S160, the processor 111 of the vehicle 100 controls the actuator group 120 by using the received traveling control signal, to cause the vehicle 100 to travel at the acceleration and the steering angle represented by the traveling control signal. The processor 111 repeatedly executes, at a predetermined cycle, the reception of the traveling control signal and control of the actuator group 120. With the system 50 according to the present embodiment, the vehicle 100 can be caused to travel by the remote control, and the vehicle 100 can move without using a transport facility, such as a crane or a conveyor.

### B: Traveling Control Example 2

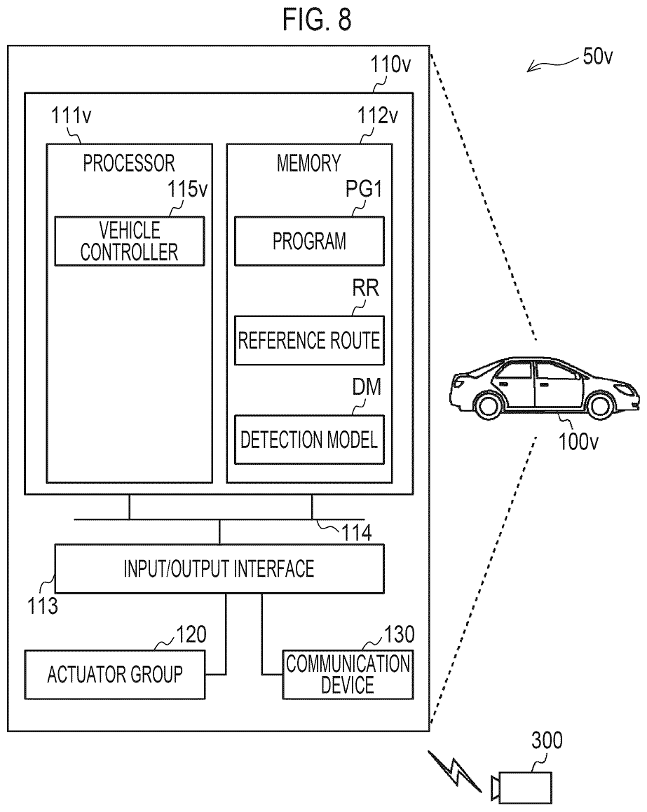

FIG. 8 is a description diagram showing a schematic configuration of a system 50v in the traveling control example 2. In the present embodiment, the system 50v is different from the traveling control example 1 in that the system 50v does not include the server 200. In addition, a vehicle 100v in the configuration can travel by the autonomous control of the vehicle 100v. Other configurations are the same as the configuration described above unless otherwise specified.

In the present embodiment, a processor 111v of a vehicle control device 110v functions as a vehicle controller 115v by executing the program PG1 stored in a memory 112v. The vehicle controller 115v can acquire the output result of the sensor, generate the traveling control signal by using the output result, and output the generated traveling control signal to operate the actuator group 120, thereby causing the vehicle 100v to travel via the autonomous control. In the present embodiment, the detection model DM and the reference route RR are stored in the memory 112v in addition to the program PG1.

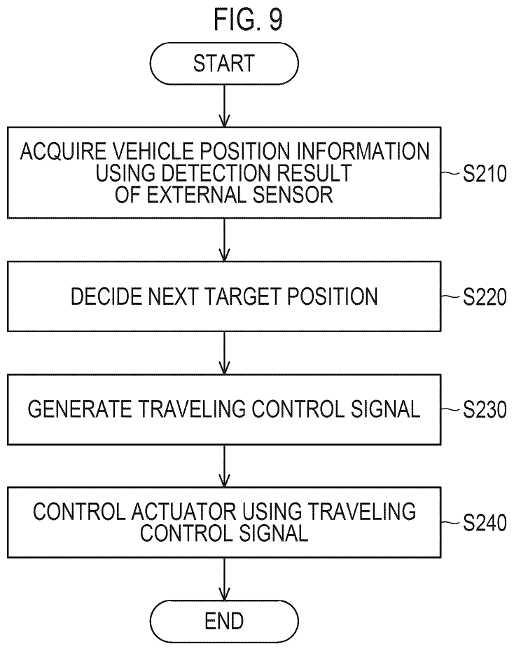

FIG. 9 is a flowchart showing a processing procedure of traveling control of the vehicle 100v in Example 2. In the processing procedure of FIG. 9, the processor 111v of the vehicle 100v executes the program PG1 to function as the vehicle controller 115v.

In step S210, the processor 111v of the vehicle control device 110v acquires the vehicle position information by using the detection result output from the camera that is the external sensor 300. In step S220, the processor 111v decides the target position to which the vehicle 100v should go next. In step S230, the processor 111v generates the traveling control signal for causing the vehicle 100v to travel toward the decided target position. In step S240, the processor 111v controls the actuator group 120 by using the generated traveling control signal, to cause the vehicle 100v to travel in accordance with the parameters represented by the traveling control signal. The processor 111v repeatedly executes, at a predetermined cycle, the acquisition of the vehicle position information, the decision of the target position, the generation of the traveling control signal, and the control of the actuator. With the system 50v according to the present embodiment, the vehicle 100v can be caused to travel via the autonomous control of the vehicle 100v without the need for the server 200 to remotely control the vehicle 100v.

### YY: Other Traveling Control Example

(YY1) In the example, the external sensor 300 is a camera. However, the external sensor 300 need not be the camera, and may be, for example, a light detection and ranging (LiDAR). In this case, the detection result output by the external sensor 300 may be three-dimensional point cloud data representing the vehicle 100. In this case, the server 200 or the vehicle 100 may acquire the vehicle position information via template matching using the three-dimensional point cloud data as the detection result, and reference point cloud data prepared in advance.
(YY2) In the traveling control example 1, the server 200 executes the processing from the acquisition of the vehicle position information to the generation of the traveling control signal. On the other hand, the vehicle 100 may execute at least a part of the processing from the acquisition of the vehicle position information to the generation of the traveling control signal. For example, the following forms (1) to (3) may be used.
(1) The server 200 may acquire the vehicle position information, decide the target position to which the vehicle 100 should head next, and generate the route from the current position of the vehicle 100 represented by the acquired vehicle position information to the target position. The server 200 may generate a route to the target position between the current position and the destination or may generate a route to the destination. The server 200 may transmit the generated route to the vehicle 100. The vehicle 100 may generate the traveling control signal for causing the vehicle 100 to travel on the route received from the server 200, and control the actuator group 120 by using the generated traveling control signal.
(2) The server 200 may acquire the vehicle position information and transmit the acquired vehicle position information to the vehicle 100. The vehicle 100 decides the target position to which the vehicle 100 should head next and generates the route from the current position of the vehicle 100 represented by the received vehicle position information to the target position. Then, the vehicle 100 may generate the traveling control signal such that the vehicle 100 travels on the generated route, and control the actuator group 120 by using the generated traveling control signal.
(3) In the forms (1) and (2), an internal sensor may be mounted on the vehicle 100, and a detection result output from the internal sensor may be used for at least one of the generation of the route and the generation of the traveling control signal. The internal sensor is a sensor mounted on the vehicle 100 and corresponds to the external environment sensor 140 shown in FIG. 2. The internal sensor may include, for example, a sensor that detects a motion state of the vehicle 100, a sensor that detects an operation state of each unit of the vehicle 100, or a sensor that detects a surrounding environment of the vehicle 100. Specifically, the internal sensor may include, for example, a camera, a LiDAR, a millimeter wave radar, an ultrasound sensor, a GPS sensor, an acceleration sensor, and a gyro sensor. For example, in the form (1), the server 200 may acquire the detection result of the internal sensor and reflect the detection result of the internal sensor in the route when the route is generated. In the form (1), the vehicle 100 may acquire the detection result of the internal sensor and reflect the detection result of the internal sensor to the traveling control signal when the traveling control signal is generated. In the form (2), the vehicle 100 may acquire the detection result of the internal sensor and reflect the detection result of the internal sensor to the route when the route is generated. In the form (2), the vehicle 100 may acquire the detection result of the internal sensor and reflect the detection result of the internal sensor to the traveling control signal when the traveling control signal is generated.
(YY3) In the traveling control example 2, the internal sensor may be mounted on the vehicle 100v, and the detection result output from the internal sensor may be used for at least one of the generation of the route and the generation of the traveling control signal. For example, the vehicle 100v may acquire the detection result of the internal sensor and reflect the detection result of the internal sensor to the route when the route is generated. The vehicle 100v may acquire the detection result of the internal sensor and reflect the detection result of the internal sensor to the traveling control signal when the traveling control signal is generated.
(YY4) In the traveling control example 2, the vehicle 100v acquires the vehicle position information by using the detection result of the external sensor 300. On the other hand, the internal sensor is mounted on the vehicle 100v, and the vehicle 100v acquires the vehicle position information by using the detection result of the internal sensor and decides the target position to which the vehicle 100v should go next. Further, the vehicle 100v may generate a route from the current position of the vehicle 100v represented by the acquired vehicle position information to the target position, generate a traveling control signal for traveling on the generated route, and control the actuator group 120 by using the generated traveling control signal. In this case, the vehicle 100v can travel without using the detection result of the external sensor 300 at all. The vehicle 100v may acquire a target arrival time or traffic jam information from the outside of the vehicle 100v and reflect the target arrival time or the traffic jam information to at least one of the route and the traveling control signal. In addition, all of the functions of the system 50v may be provided in the vehicle 100v. That is, the processing implemented by the system 50v according to the present disclosure may be implemented by the vehicle 100v alone.
(YY5) In the traveling control example 1, the server 200 automatically generates the traveling control signal to be transmitted to the vehicle 100. On the other hand, the server 200 may generate the traveling control signal to be transmitted to the vehicle 100 in response to an operation of an external operator who is located outside the vehicle 100. For example, the external operator operates a control device including a display that displays the captured image output from the external sensor 300, a steering wheel, an accelerator pedal, and a brake pedal for remotely operating the vehicle 100, and a communication device that communicates with the server 200 via the wired communication or the wireless communication. The server 200 may generate the traveling control signal in accordance with the operation applied to the control device.
(YY6) In each of the traveling control examples, the vehicle 100 may be configured to move via the unmanned driving, and may be, for example, a platform having a configuration described below. Specifically, the vehicle 100 solely needs to include at least the vehicle control device 110 and the actuator group 120, in order to exhibit the three functions of “traveling”, “turning”, and “stopping” via the unmanned driving. In a case where the vehicle 100 acquires the information from the outside for the unmanned driving, the vehicle 100 need solely further include the communication device 130. That is, the vehicle 100 that can move via the unmanned driving need not be mounted with at least a part of the interior components, such as the driver's seat and the dashboard, need not be mounted with at least a part of the exterior components, such as the bumper and the fender mirror, and need not be mounted with the bodyshell. In this case, the remaining components, such as the bodyshell, may be mounted in the vehicle 100 before the vehicle 100 is shipped from a factory FC, or the remaining components, such as the bodyshell, may be mounted in the vehicle 100 after the vehicle 100 is shipped from the factory FC in a state where the remaining components, such as the bodyshell, are not mounted in the vehicle 100. Each of the components may be mounted from any direction, such as the upper side, the lower side, the front side, the rear side, the right side, or the left side of the vehicle 100, and may be mounted from the same direction or different directions. The position decision can be made for the form of the platform in the same manner as the vehicle 100 according to the first embodiment.
(YY7) The vehicle 100 may be manufactured by combining a plurality of modules. The module means a unit configured by a plurality of components assembled depending on the part or the function of the vehicle 100. For example, the platform of the vehicle 100 may be manufactured by combining a front module that constitutes a front portion of the platform and a center module that constitutes a center portion of the platform. Further, the platform of the vehicle 100 may be manufactured by adding a rear module that constitutes a rear portion of the platform. In addition, the number of modules constituting the platform is not limited to three, and may be two or less or four or more. In addition to or instead of the components constituting the platform, the components constituting a portion of the vehicle 100 that is different from the platform may be modularized. In addition, various modules may include any exterior component, such as a bumper or a grille, or any interior component, such as a seat or a console. In addition, the present disclosure is not limited to the vehicle 100, a mobile object of any aspect may be manufactured by combining the modules. Such a module may be manufactured, for example, by joining the components via welding or a fastener, or may be manufactured by integrally molding at least a part of the components constituting the modules as one component via casting. A molding method of integrally molding one component, particularly a relatively large component, is also called giga casting or mega casting. For example, the front module, the center module, and the rear module may be manufactured by using giga casting.
(YY8) The transport of the vehicle 100 using the traveling of the vehicle 100 via the unmanned driving is also referred to as “autonomous transport”. In addition, a configuration for implementing the autonomous transport is also referred to as “vehicle remote control autonomous driving transport system”. Further, a production method of producing the vehicle 100 by using the autonomous transport is also referred to as “autonomous production”. In the autonomous production, for example, at the factory FC that manufactures the vehicle 100, at least a part of the transport of the vehicle 100 is implemented by the autonomous transport.
(YY9) In each of the traveling control examples, a part or all of the functions and the processing that are software-implemented may be hardware-implemented. Further, a part or all of the functions and the processing that are implemented by hardware may be implemented by software. As the hardware for implementing various functions in each of the embodiments, for example, various circuits, such as an integrated circuit or a discrete circuit, may be used.

In the present disclosure, the processing of the external sensor 300, the vehicle 100, the server 200, and the like described above can be realized by causing a central processing unit (CPU) to execute a computer program.

The program includes an instruction group (or software code) for causing a computer to execute one or more functions described in the embodiment in a case where the program is read into the computer. The program may be stored on a non-transitory computer-readable medium or a tangible storage medium. As an example, but not limited thereto, the computer-readable medium or the tangible storage medium includes a random-access memory (RAM), a read-only memory (ROM), a flash memory, a solid-state drive (SSD), or other memory technologies. In addition, a CD-ROM, a digital versatile disc (DVD), a Blu-ray (registered trademark) disc, or other optical disk storage is also included. Further, a magnetic cassette, a magnetic tape, a magnetic disk storage, or other magnetic storage devices are also included. The program may be transmitted on a transitory computer-readable medium or a communication medium. Examples of the transitory computer-readable medium or the communication medium include electrical, optical, acoustic, or other forms of propagating signals, but the transitory computer-readable medium or the communication medium is not limited to the examples.

Although the present disclosure has been described with reference to the embodiments, the present disclosure is not limited to the embodiments. Various changes that can be understood by the person skilled in the art within the scope of the present disclosure can be made to the configuration or the details of the present disclosure. Each embodiment can be appropriately combined with another embodiment.

What is claimed is:

1. A vehicle management system comprising:
a plurality of vehicles configured to move via unmanned driving; and
a management device configured to manage an operation of the vehicles, wherein:
each of the vehicles includes an external environment sensor configured to detect a surrounding obstacle;
the management device includes
a communication unit configured to receive a detection result of the external environment sensor,
a controller configured to control, based on the detection result of the external environment sensor and a captured image obtained by a first surveillance camera capturing an image of a first area, the operation of the vehicles moving in the first area, and
an output unit configured to output, in a case where a malfunction of the external environment sensor of some of vehicles among the vehicles moving in the first area is detected, information indicating a possibility of a failure in the external environment sensor in which the malfunction is detected; and
the controller is configured to control, in a case where the malfunction of the external environment sensor of each of the vehicles moving in the first area is detected, the operation of the vehicles moving in the first area based on the captured image obtained by the first surveillance camera.

2. The vehicle management system according to claim 1, wherein the controller is configured to stop, in a case where the malfunction of the external environment sensor of some of the vehicles among the vehicles moving in the first area is detected, movement of the vehicle in which the malfunction is detected.

3. The vehicle management system according to claim 1, wherein the external environment sensor includes a plurality of kinds of sensors including
an in-vehicle camera configured to capture surroundings,
a radar configured to detect the surrounding obstacle, and
a light detection and ranging (LiDAR) configured to detect the surrounding obstacle.

4. The vehicle management system according to claim 3, wherein the controller is configured to:
control, in a case where a malfunction is detected in the number of kinds of sensors that is fewer than a predetermined number of kinds of sensors among the kinds of sensors that are included in the external environment sensor provided in each of the vehicles moving in the first area, the operation of the vehicles moving in the first area based on a detection result of a sensor in which the malfunction is not detected among the kinds of sensors that are included in the external environment sensor provided in each of the vehicles and the captured image obtained by the first surveillance camera; and
cause, in a case where the malfunction is detected in the number of kinds of sensors that is equal to or more than the predetermined number of kinds of sensors among the kinds of sensors that are included in the external environment sensor provided in each of the vehicles moving in the first area, the vehicles moving in the first area to stop moving.

5. The vehicle management system according to claim 1, further comprising a database in which a plurality of combinations of an operation status of the external environment sensor provided in the vehicle, an area in which the vehicle moves, and control content of the operation of the vehicle is stored,
wherein the controller is configured to extract the control content of the operation of the vehicle in accordance with the operation status of the external environment sensor provided in each of the vehicles moving in the first area from the database.
